(19) United States
(12) Patent Application Publication
(10) Pub. No.: US 2008/0040934 A1
(43) Pub. Date: Feb. 21, 2008

(54) Blade of a Paper Shredder

(76) Inventor: Gu-ming ZENG, Guangdong (CN)

Correspondence Address: CARSTENS & CAHOON, LLP, P O BOX 802334, DALLAS, TX, 75380, US

(21) Appl. No.: 11/562,092

(22) Filed: Nov. 21, 2006

(30) Foreign Application Priority Data
May 26, 2006 (CN) 200620014030.9

(51) Int. Cl. B67B 7/70

(52) U.S. Cl. 30/418

(57) ABSTRACT

The present invention provides a blade of a paper shredder, characterized in that the serrated cutting edge and the circular blade body are integrally formed from the base material, and the serrated cutting edge is formed by bending the periphery of the blade body; the serrated cutting edge has a front face bent from the periphery of the blade body, such that the width of the cutting edge is larger than the thickness of the blade body. The blade of the present invention requires simple processing and low material consumption, and the paper scrap from the shredder can be discharged smoothly.

### CROSS-REFERENCE TO RELATED APPLICATION

This application claims priority of CN Patent Application No. 200620014030.9 filed on May 26, 2006, entitled “Blade of a Paper Shredder” , which is incorporated herein by reference for all purposes.

### TECHNICAL FIELD

The present invention relates to a paper shredder for office use, and more particularly to improvements on the structure of a blade of the paper shredder, so as to reduce the material consumption for the blade.

### BACKGROUND ART

It is known in the prior art that, as a very important component in a paper shredder, the blade is an important factor for evaluating the quality of the paper shredder. Meanwhile, the blade is an easily worn component and has to be frequently replaced due to high frequency of usage. In a conventional paper shredder, multiple sets of blades are arranged on opposing rotary shafts, wherein two blades are combined into each set of blades in a back-to-back manner. Each blade has a circular blade body and serrated cutting edges, and the circular blade body and serrated cutting edges of one blade is kept in contact with the counterpart of the other blade of a same set. The sets of blades are spaced apart at a distance equal to the width of the shredded wastepaper. In prior art, there are two methods to meet the above design requirements. One method is that the blade body and the serrated cutting edge are integrally formed and punched from a same base material. As a result, both of the blade body and the serrated cutting edge have the thickness of the base material. The production cost is high due to the high-level requirements for the material of the blade body, and due to the high material consumption for making a blade with such a structure. The other method is that the blade body is designed into a curved profile or the serrated cutting edges are specially thickened to reduce the material consumption. However, a blade with such a structure has a complex shape and needs complicated processing.

### SUMMARY OF THE INVENTION

In order to overcome the disadvantages of prior art, such as high material consumption, high manufacturing cost, complex shape of a profiled blade, and difficulties in processing, the present invention provides a blade of a simple structure for a paper shredder. The blade of the present invention requires simple processing and low material consumption, and the paper scrap from the shredder can be discharged smoothly with the blade of the present invention equipped.

The technical solution of the present invention is as follows:

A blade of a paper shredder comprises a circular blade body with a center hole for mounting the blade on a rotary shaft, and the circular blade body has at least one serrated cutting edge at its outer periphery, wherein the serrated cutting edge and the circular blade body are integrally formed from the base material, and the serrated cutting edge is formed by bending the periphery of the blade body; the serrated cutting edge has a front face bent from the periphery of the blade body, such that the width of the cutting edge is larger than the thickness of the blade body.

Wherein the front face of the serrated cutting edge extends forward at its inner end so as to form a consecutive bottom face for discharging the paper scrap;

Wherein the front face and the bottom face of the serrated cutting edge are integrally bent from the periphery of the blade body.

Wherein the front face and the bottom face of the serrated cutting edge are 75-110 degrees bent from the periphery of the blade body.

Wherein the front face and the bottom face of the serrated cutting edge are substantially 90 degrees bent from the periphery of the blade body.

Wherein the circular blade body has two or more than two serrated cutting edges on its outer periphery, and the serrated cutting edges are evenly spaced.

Wherein the circular blade body has at least one annular protrusion around the center hole, the width of the annular protrusion is equal to that of the front face of the serrated cutting edge.

Wherein the circular blade body has two or more annular protrusions evenly spaced around the center hole.

Wherein the outer periphery of the circular blade body has arc corrugations for discharging paper scrap.

The advantages of the present invention are as follows: the blade has simple structure and is easily processed. The blade of the present invention ensures a certain width of cutting and smooth discharging of the paper scrap, meanwhile it requires thinner base material and less material consumption, therefore, the manufacturing cost and the weight of the total device are greatly reduced.

### DESCRIPTION OF THE DRAWINGS

The present invention will be described according to the embodiments in conjunction with the accompanying drawings.

FIG. 1 is a perspective view of the blade of the paper shredder according to embodiment 1 of the present invention;

FIG. 2 is a front view of the blade of the paper shredder according to embodiment 2 of the present invention;

FIG. 3 is a schematic view of the blade as shown in FIG. 2 along A direction;

FIG. 4 is a schematic view showing the blade sets mounted on a rotary shaft;

FIG. 5 is a front view of the blade of the paper shredder according to embodiment 3 of the present invention.

### DETAILED DESCRIPTION OF THE PREFERRED EMBODIMENTS

Wherever possible, the same reference numbers are used in the drawings and the description to refer to the same or like parts.

### Embodiment 1

As shown in FIG. 1, the blade of the present invention comprises a circular blade body 101 with a center hole 105 for mounting the blade on a rotary shaft. The mounting hole 105 is processed into a polygonal hole, such that it facilitates the circular blade body 101 to be fixed on the rotary shaft, and on the other hand it facilitates the interlaced positioning of different sets of blade along the longitudinal direction so that the blades can cut at different positions.

The circular blade body 101 has four serrated cutting edges 102 evenly spaced at its outer periphery. The serrated cutting edges 102 and the circular blade body 101 are integrally formed from the base material, and the serrated cutting edges are formed by bending the periphery of the blade body via a bending machine. Each serrated cutting edge 102 has a front face 121 which is 75-110 degrees bent from the periphery of the blade body 101. And preferably the edge of the circular blade body 101 is perpendicular to the plane of the blade body 101 to form the front face 121 of the serrated cutting edge 102. The width of the front face 121 is generally 1.2-10 times of the thickness of the base material, and the width can be set conveniently dependant on the size of a paper shredder. This structure design allows the width of the serrated cutting edge 102 greater than the thickness of the base material of the blade body 101, so that the thickness of the base material of the blade body 101 can be reduced, the width of the serrated cutting edge 102 can be ensured, and the material and manufacturing cost are reduced.

In order to increase the rigidity of the serrated cutting edge 102 and to discharge the paper scrap, the front face 121 of the serrated cutting edge 102 extends forward at its inner end to form a consecutive bottom face 122, wherein the front face 121 and the bottom face 122 are integrally bent from the periphery of the blade body 101.

In order to increase the rigidity of the blade body 101, and to ensure a close contact between two blades of a same set to prevent paper from being stuck, the circular blade body 101 has one annular protrusion 103 around the center hole 105, and the width of the annular protrusion 103 is equal to that of the serrated cutting edge 102. In such a way, the two blades will keep in close contact when mounting in a back to back manner, so as to prevent paper from being stuck and to enhance the rigidity of the circular blade body 101.

### Embodiment 2

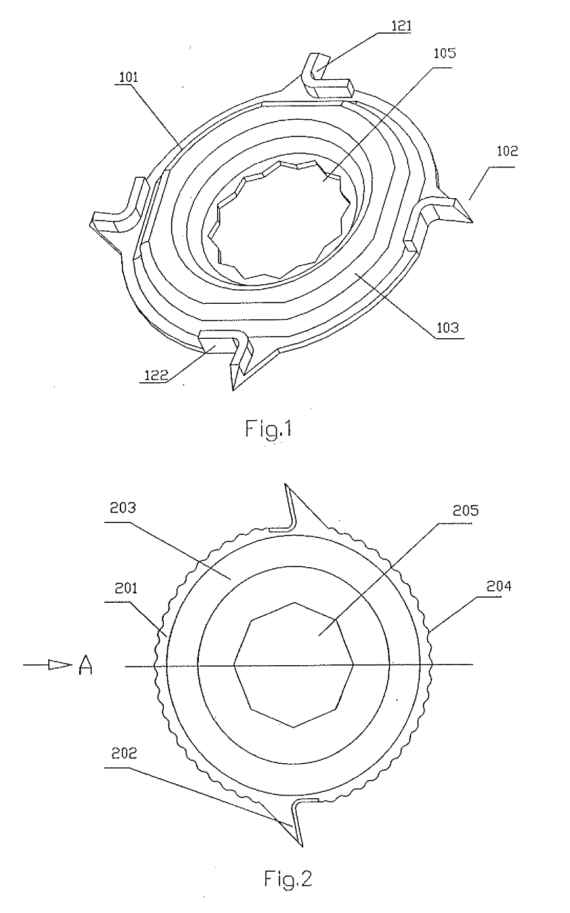

As shown in FIG. 2 and 3, the difference between embodiment 1 and 2 is that, the blade 201 of embodiment 2 has two serrated cutting edges 202.

Moreover, the outer periphery of the circular blade body 201 has arc corrugations 204 for discharging paper scrap. In this way, the friction force between the moving paper scrap and the outer periphery of the circular blade body is reduced which facilitates the paper scrap to move rapidly, so as to avoid accumulation of paper scrap and ensure the paper scrap to be discharged smoothly.

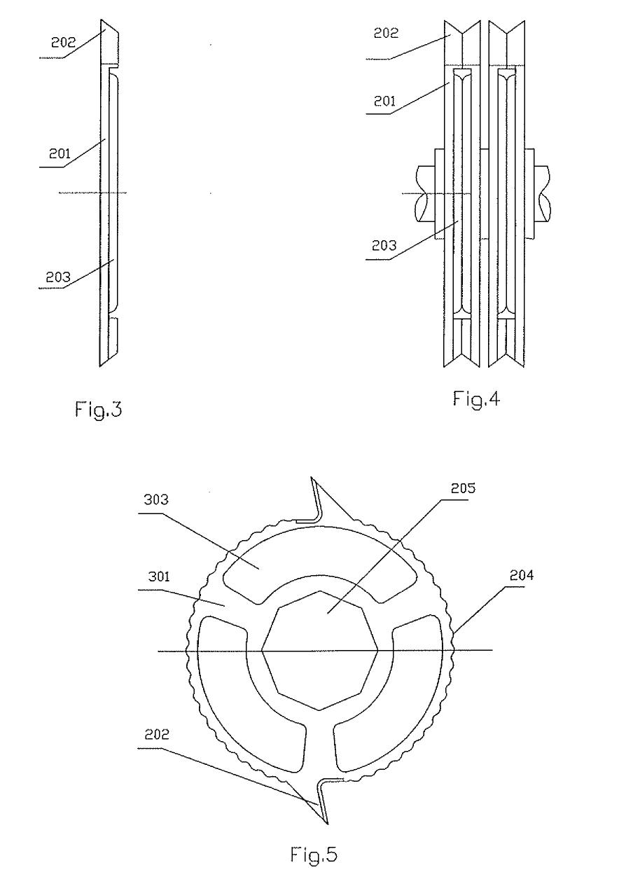

FIG. 4 shows the blade sets mounted on a rotary shaft.

### Embodiment 3

As shown in FIG. 5, the difference between embodiment 2 and 3 is that, the circular blade body 301 of embodiment 3 has three annular protrusions 303 evenly spaced around the center hole 205.

1. A blade of a paper shredder comprises a circular blade body with a center hole for mounting the blade on a rotary shaft, and the circular blade body has at least one serrated cutting edge at its outer periphery, wherein the serrated cutting edge and the circular blade body are integrally formed from the base material, and the serrated cutting edge is formed by bending the periphery of the blade body; the serrated cutting edge has a front face bent from the periphery of the blade body, such that the width of the cutting edge is larger than the thickness of the blade body.

2. The blade of a paper shredder according to claim 1, wherein the front face of the serrated cutting edge extends forward at its inner end so as to form a consecutive bottom face for discharging the paper scrap.

3. The blade of a paper shredder according to claim 2, wherein the front face and the bottom face of the serrated cutting edge are integrally bent from the periphery of the blade body.

4. The blade of a paper shredder according to claim 3, wherein the front face and the bottom face of the serrated cutting edge are 75-110 degrees bent from the periphery of the blade body.

5. The blade of a paper shredder according to claim 4, wherein the front face and the bottom face of the serrated cutting edge are substantially 90 degrees bent from the periphery of the blade body.

6. The blade of a paper shredder according to claim 1, wherein the circular blade body has at least one annular protrusion around the center hole, the width of the annular protrusion is equal to that of the front face of the serrated cutting edge.

7. The blade of a paper shredder according to claim 6, wherein the circular blade body has two or more annular protrusions evenly spaced around the center hole.

8. The blade of a paper shredder according to claim 1, wherein the outer periphery of the circular blade body has arc corrugations for discharging paper scrap.
